(19) United States
(12) Patent Application Publication
(10) Pub. No.: US 2007/0011019 A1
(43) Pub. Date: Jan. 11, 2007

(54) Managed e-commerce trading

(75) Inventor: George Eino Ruul, Applecross (AU)

Correspondence Address: CARR & FERRELL LLP, 2200 GENG ROAD, PALO ALTO, CA, 94303, US

(73) Assignee: NetFire1 Pty Ltd

(21) Appl. No.: 11/214,515

(22) Filed: Aug. 29, 2005

Related U.S. Application Data
(60) Provisional application No. 60/696,997, filed on Jul. 5, 2005.

(51) Int. Cl. G06Q 99/00

(52) U.S. Cl. 705/1

(57) ABSTRACT

Exemplary systems and methods for managing communications in an e-commerce trading environment are provided. The system comprises an e-commerce module configured to create a communication packet and an e-commerce server configured to obtain and monitor a copy of the communication packet. The monitoring may comprising searching for a particular transaction embodied within the copy of the communication packet in order to review details of the transaction. Alternatively, the monitoring may comprise generate a statistical report based on characteristics of the transactions.

### CROSS REFERENCE TO RELATED APPLICATION

The present application claims the priority benefit of Provisional Patent Application Ser. No. 60/696,997, filed Jul. 5, 2005 and entitled “System and Method for Optimized E-Commerce Trading,” which is incorporated herein by reference.

### BACKGROUND OF THE INVENTION

1. Field of the Invention

The present invention relates generally to e-commerce, and more particularly to management in an e-commerce trading environment.

2. Description of Related Art

The Internet has developed into a dominate force in the global business market. Businesses may now sell products, deal with vendors, promote items, sell directly to consumers, and so forth via the Internet. For large companies having resources to set up and maintain websites that offer products for sale along with the mechanisms for contracting the sale, the ability to reach out to consumers is relatively easy. Smaller businesses, however, may not have the capability to do the same.

Typically, businesses list products on its own website for purchasers to access. The product, prices, and availability must be maintained up-to-date on these websites. This is often a time consuming and expensive process.

On the consumer-side, a prospective buyer may visit multiple websites in order to determine the best price for a particular product—a very time consuming process. Alternatively, the buyer may depend on a shopping comparison site to search out the best price. These shopping comparison sites, however, typically only provide dated information obtained from, or “pushed” by, seller websites. Thus, if a seller does not have a website, has not updated their website recently, or has not “pushed” a recent copy of their inventory to a comparison site central database, the information obtained by the consumer may not contain the best price or most updated data available.

FIG. 1A shows one prior art e-commerce network and database architecture 100. As shown, a vendor provides copies of their inventory database 102 information to a central database at a website 104. Oftentimes, the business inventory database 102 is kept on a computing device/system that is not directly connected to the website 104 hosting device. Thus, the vendor must manually move a copy of the inventory database 102 information to a central database at the website 104. Alternatively, a web crawler may gather product information and deposit the information in the central database.

A client or buyer 106 may then view this website 104, and query 108 for information on a product of interest. If a product of interest is found, the client may send an order 110 to the website 104. Once the order 110 is fulfilled, the inventory database 102 must be updated. In the present example, the inventory database 102 is manually updated after receipt of an e-mail from the website 106.

Although the above architecture 100 is simple to implement, it is often quite slow and does not cater to having multiple vendors in a transparent manner. Accordingly, an alternative prior art e-commerce architecture 120, as shown in FIG. 1B, may be utilized. This architecture 120 uses ASP (application service provider) type functions to query a vendor database 122. A result is then returned in a web-based format to the querying client 124. While this architecture 120 may support multiple vendor databases 122, the network communications are often quite complex, thus resulting in slow communications. Additionally, complex queries across multiple vendor databases 122 may require extensive network communications which will be extremely slow and inefficient.

Disadvantageously, many of the prior art systems also do not allow for hidden management of the trading process—that is management of the trading process without monitoring that is obvious to the customer or seller. The monitoring may be useful in order to authenticate the customer, seller, and transactions. Authentication provides a layer of trust and protection to the e-commerce trading environment. The monitoring may also provide valuable statistical information. Therefore, there is a need for a system and method for managing the e-commerce trading environment.

### SUMMARY

The present invention provides exemplary systems and methods for managing communications in an e-commerce trading environment. The system comprises an e-commerce module configured to create a communication packet and an e-commerce server configured to obtain and monitor a copy of the communication packet. In one embodiment, the e-commerce module creates both the communication packet and a copy of the communication packet. The communication packet is sent to other parties in the transaction while the copies either sent to the e-commerce server in real time or stored to a secure database.

In an alternative embodiment, the e-commerce module only creates the communication packet. During delivery to other parties in the transaction, the communication packet is routed through the e-commerce server where a copy of the communication packet is made. In one embodiment, the e-commerce server is an e-community administrator.

The monitoring by thee-commerce server may comprise searching for a particular transaction embodied within the copy of the communication packet in order to review details of the transaction. Alternatively, the monitoring may comprise generating a statistical report based on characteristics of the transactions.

### BRIEF DESCRIPTION OF THE DRAWINGS

FIG. 1A is prior art e-commerce architecture;

FIG. 1B is an alternative prior art e-commerce architecture;

FIG. 2 is a simplified, e-commerce architecture in which the present invention may be practiced;

FIG. 3 is an exemplary e-commerce server according to one embodiment;

FIG.4 shows an example of management in a direct access product search scenario;

FIG.5 shows an example of management in an indirect access product search scenario; and

FIG. 6 shows an example of management in an exemplary e-community environment.

### DESCRIPTION OF EXEMPLARY EMBODIMENTS

The present invention provides systems and methods for managing e-commerce trading. Embodiments of the present invention allow a specialized e-commerce server to monitor communications and transactions between a plurality of buyers (e.g., consumer or customer) and sellers (e.g., retailer/vendors) in a real-time e-commerce environment. In exemplary embodiments, the e-commerce environment provides a customer with a direct link with the retailers'/vendors' inventory database, instead of a gigantic, central database. This allows access to the most current inventory and pricing information available to the end user since it is direct from the source (i.e., vendor).

Unlike prior art systems, the present system is scalable; thus, product and inventory data does not need to be centralized or recreated (at a central database website). Instead, existing vendor/retail inventory databases can be “plugged” into embodiments of the present invention without much effort. Further, the present invention provides fast, efficient, and secure communication by using a peer-to-peer model, in some embodiments, over a Virtual Private Network (VPN) which may be monitored. Because the present invention does not rely on HTML/XML browser technology, the present invention requires much less data transfer for information to be sent across the network.

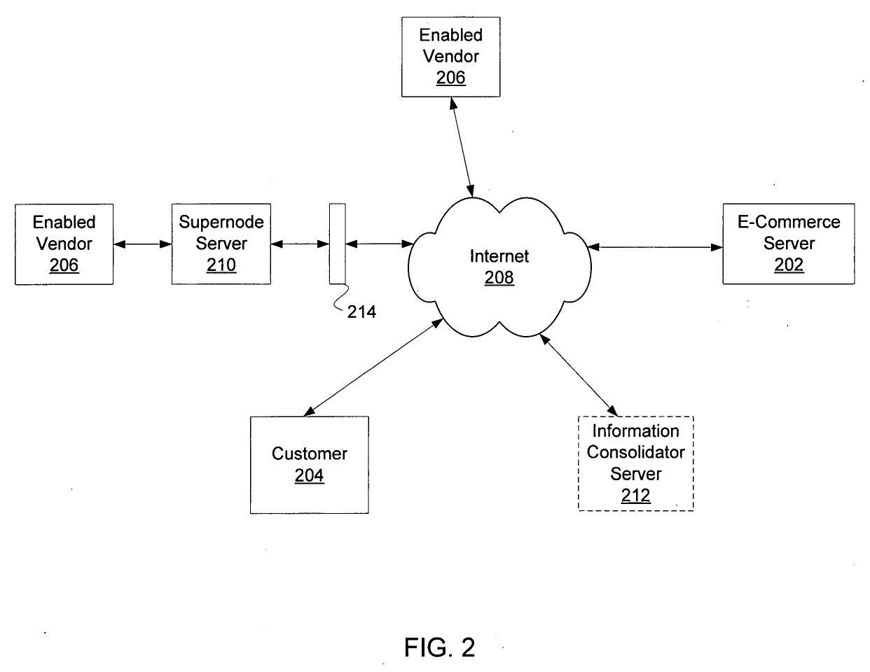

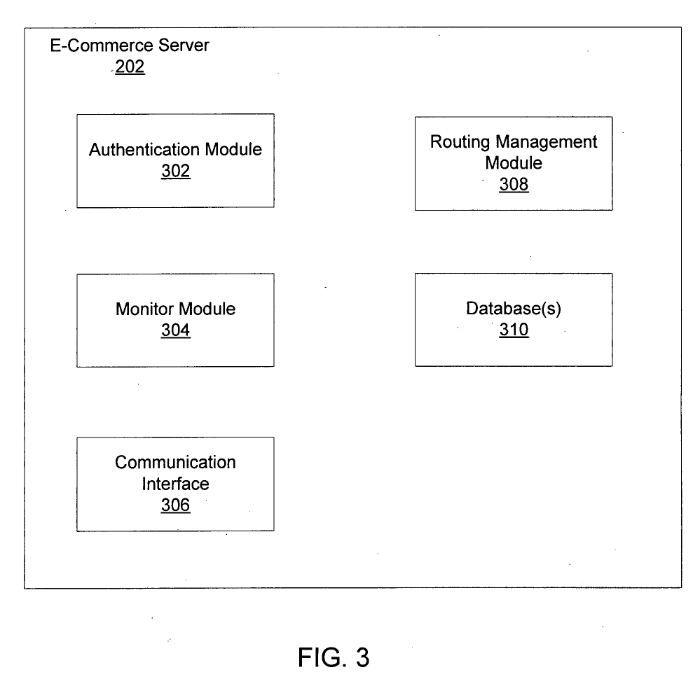

FIG. 2 shows an exemplary e-commerce architecture 200 in which the present invention may be practiced. The architecture 200 comprises various e-commerce components including an e-commerce server 202, at least one customer 204, and one or more enabled vendors 206 all coupled for communication via the Internet 208. An optional supernode server 210 and information consolidator server 212 may also be provided in the e-commerce architecture 200. These e-commerce components allow a plurality of enabled vendors 206 to offer products directly to a plurality of customers 204 accessing the e-commerce system. Plug-ins may be further adapted into the system to customize the system for the vendors 206 and customers 204 as will be described herein. The e-commerce server 202 will be discussed in more detail in connection with FIG. 3.

It should be noted that the architecture 200 of FIG. 2 is exemplary. Alternative embodiments may comprise more or fewer components. For example, more than one information consolidator server 212 or e-commerce server 202 may be provided (e.g., regionally based). Furthermore, any number of vendors 206 and/or customers 204 may be present on the system.

In exemplary embodiments, the system communicates across the Internet 208 using a specialized GUID-over-IP transport mechanism. The specialized transport mechanism allows e-commerce enabled systems to be coupled through a network of internal and external routers, proxies, and firewalls 214 without requiring reconfiguration of the various communications equipment. Routing management allows for control over pathways taken by communicating entities, thus allowing for monitoring to be implemented. This may be an important feature for sensitive communities. Additionally, load balancing and N-tier construction allow for efficient scale out rather than scale up implementations.

Additionally, a non-repudiation protocol may be utilized to insure integrity in the system. For example, origin of data exchanged over the architecture 200 is known and tracked. In one embodiment, electronic certificates may be utilized to guarantee that communications are delivered only to the intended recipient(s), that the transmission is secure, and that the identity of the sender is controlled. Timestamps and encryption keys may also be a part of the non-repudiation protocol. AS2 (Applicability Statement 2) secure transport protocol may, in some embodiments, be utilized to provide the non-repudiation protocol.

In an embodiment where the enabled vendor 206 is located behind the firewall 214, the supernode server 210 may be utilized. Specifically, the supernode server 210 allows a user to communicate through the firewall 214 by directing network traffic through a standard HTTP port (e.g., Port 80). These supernode servers 210 may be deployed within specific trading communities (e.g., privately established set of sellers) or in a common central pool. Thus, the system is scalable for each trading community.

The coupled computing devices of the enabled vendors 206 and the customers 204 may comprise one or more e-commerce modules which allow operation of the present invention and for customization. These client e-commerce modules may include a web server, a software developer kit (SDK), a plug-in coordinator, and a messaging server. The web server allows web-based interactions with other system installations. The exemplary SDK allows use of plug-ins to interface with existing applications and databases, while the plug-in coordinator allows a selectable choice of enabled applications with message marshalling to appropriate applications. The plug-in coordinator may also allow the user to customize the system (e.g., available services to the end user/customer) via software plug-ins. For example, a vendor 206 may create a plug-in that gives customers 204 access to historical purchasing information or a more sophisticated catalogue. Furthermore, back end integration with legacy products can be achieved with a custom plug-in, such as a plug-in that allows direct access to the vendor's inventory database. Finally, the messaging server ensures robust communication with other community members with built-in, non-repudiation protocols.

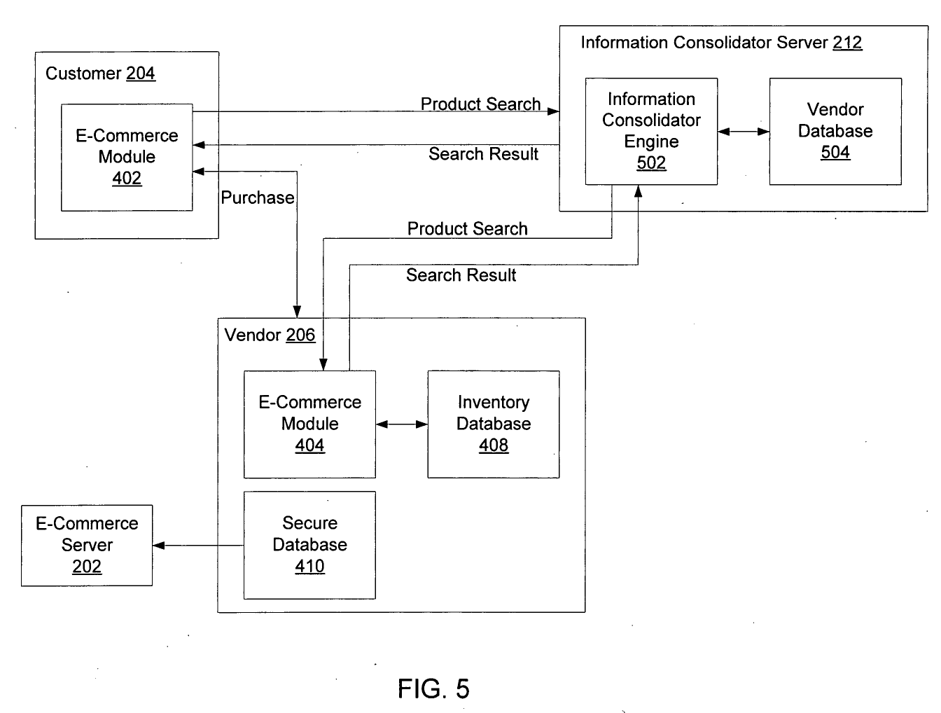

The optional information consolidator server 212 may collect data from one or more enabled user systems. Information may be pushed to the information consolidator server 212 when processing loads on the system is low. The consolidator server 212 may then be used for information analysis (e.g., sales and usage statistics) or as an information broker (i.e., passing data to other systems). In further embodiments, the information consolidator server 212 may additionally, or alternatively, act as a clearing house for data transfers to other coupled Internet systems. The information consolidator server 212 will be discussed in more detail in connection with the example of FIG. 5.

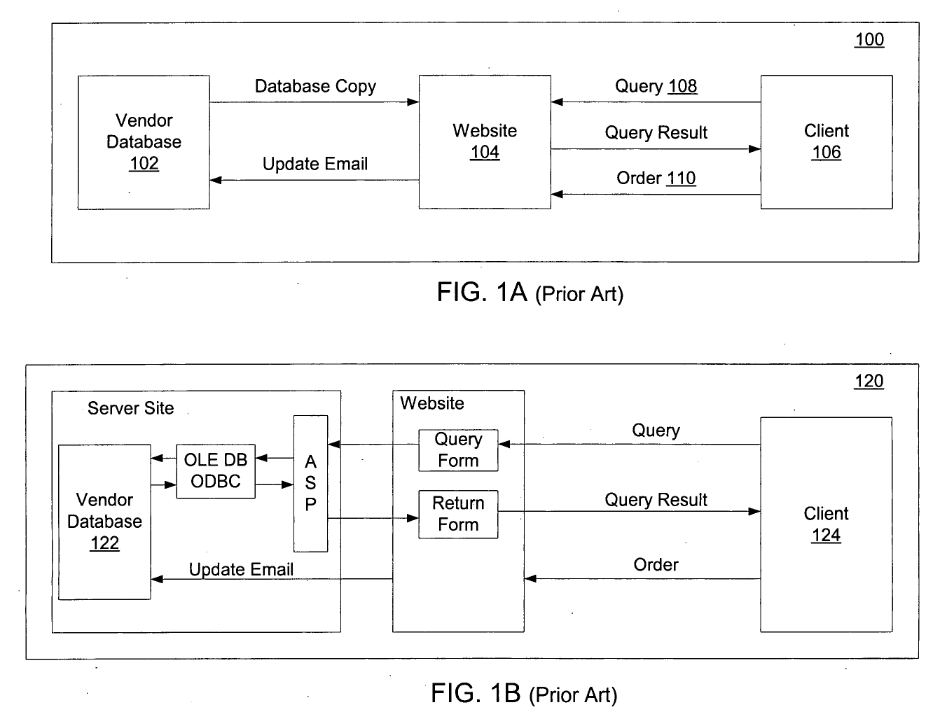

In a further embodiment, a payment gateway may be coupled to the e-commerce system of FIG. 1. The payment gateway adds a financial tie-in (e.g., relationship with financial institutions) to insure payment for any transaction. For example, the payment gateway may couple a credit card provider with the plurality of vendors 206, thus providing vendors with an ability to verify payment prior to shipping of purchased items, for example.

Referring now to FIG. 3, the exemplary e-commerce server 202 is shown in more detail. In exemplary embodiments, the e-commerce server 202 comprises an authentication module 302, a monitor module 304, a communication interface 306, a routing management module 308, and at least one database 310. In further embodiments, the database 310 may comprise a plurality of databases, each storing designated data. For example, the e-commerce server 202 may comprise an authentication database (e.g., containing user information), a monitor database (e.g., storing transaction information), and an e-commerce database (e.g., storing various e-commerce plug-ins and modules that may be accessed and downloaded onto vendor or customer devices). In yet a further embodiment, the e-commerce server 202 is coupled to the database(s) 310 which are located outside of the e-commerce server 202.

The exemplary authentication module 302 authenticates users (both vendors and customers) and their e-communities. When a user first registers with the e-commerce server 202, the user provides user data such as user name, password, and contact information. This information is then stored into the database 310. Authentication may occur seamlessly and unobtrusively to the user. In one embodiment, the authentication process may comprise verifying user names and passwords stored in the database 310. Alternative methods for authenticating users may be utilized, such as verifying IP addresses in communications sent between the parties versus addresses stored in the database 310.

Regardless of the authentication method, the e-commerce server 202 will receive authentication information from the users via the communication interface 306. The authentication module 302 then compares the received authentication information to authentication information stored in the database 310. Therefore, any user accessing or utilizing the system is known to the system and, based on permissions associated with the user, enabled to interact with specified trading community members or the system at large. The authentication may occur during an initial connection with the system (e.g., login at a start of a session). In alternative embodiments, authentication may occur at times other then initial connection, such as when a purchase transaction occurs.

In a further embodiment, the e-commerce server 202 receives copies of some or all packets sent between vendors and customers. The monitor module 304 monitors communications between the vendors 204 and customers 202 via these packet copies. By monitoring communications, integrity (e.g., verifying buyer and sellers) of the system may be insured. In one embodiment, the packet copies are received by the communication interface 306 and stored into the database 310. The monitor module 304 may then review the stored packet copies at any time. Alternatively, the packet copies may be reviewed prior to storing on the database 310.

It should be noted that not all packet copies may be reviewed. Instead, random packets may be reviewed by the monitor module 304. In further embodiments, the monitor module 304 may store all the packets into the database 310 and review packets on-demand. For example, if an issue arises, such as a customer 202 or vendor 204 disputing a particular transaction, the monitor module 304 accesses the database 310 to obtain the transaction information for review. Thus, this embodiment provides for a searchable query, via the monitor module 204, of the stored copies in the database 310. The query may be conducted by the vendor 206, customer 204, a system administrator, or any other authorized individual. Thus, for example, the vendor 206 may communicate with or access the e-commerce server 202 and enter query terms to find a copy of a particular transaction.

Additionally, the monitor module 304 may review and verify different aspects of the copied packet information. In one embodiment, the monitor module 304 reviews and verifies the identities of the customer 202 and vendor 204. In a further embodiment, the monitor module 304 prepares statistical reports based on the content of the copies. For example for a particular vendor, the monitor module 304 can determine how many, how much, and/or when particular products are sold over a certain time period. Statistics may also be determined for a collection of vendors (e.g., a chain store of vendors), between certain vendors, and between certain vendors and customers. For example, a wholesale vendor's transactions with a retailer vendor may be monitored and statistical reports generated thereon. Statistical reports regarding any aspect of transactions between two or more parties (e.g., customers and/or vendors) is within the scope of exemplary embodiments of the present invention.

The statistical reports may then be provided to the vendor 206 or any other user. The statistical reports may be stored in the database 310 for the user to access, be electronically delivered periodically to the user, or delivered via any other means and on any schedule to the user.

In one embodiment, the user may access the e-commerce server 202 and via the monitor module 304, input terms for the statistical analysis report. For example, the vendor 206 can access the e-commerce server 202 and request that transactions with customers in several regions be reviewed and a breakdown of sales for each region be provided in a comparison chart.

The exemplary routing management module 308 provides routing instructions that allow for control of pathways taken by communications. In one embodiment, the use of routing instructions allows the system to monitor the communications by routing a copy of the communication packet to the e-commerce server 200.

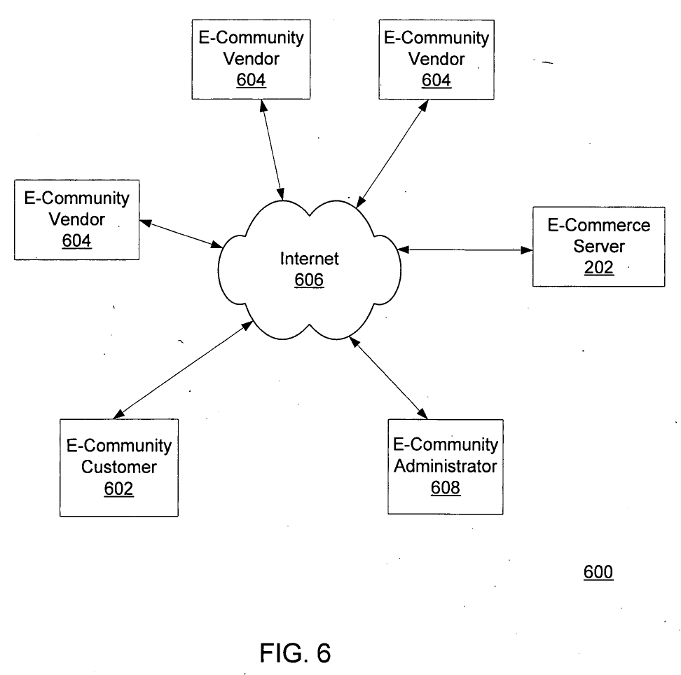

Alternatively, the communication packets, themselves, may be routed to the e-commerce server 202 prior to their final destination. For example, the routing protocol associated with a communication packet may provide for a third address (wherein the first address is the sender address and the second address is the receiver address). By redirecting the communication packet(s) through the third address (e.g., e-commerce server 202 or an administrator), the system can monitor the communication packet(s). In the example with the administrator (discussed in more detail in the example of FIG. 6), the administrator can receive the communication packet(s), strip the packet(s) in order to access the content, and if the content is permissible, redirect the packet(s) to the receiver.

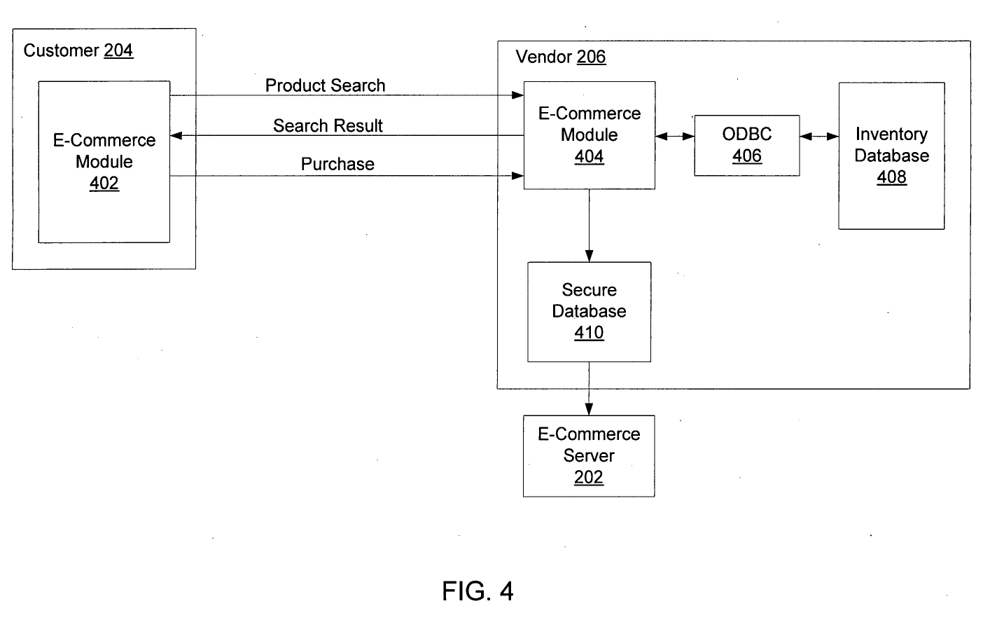

Referring now to FIG. 4, an exemplary management scenario of a direct product search by a customer 204 is shown. The customer 204 may be a user on a computer, a mobile phone or device (e.g., thin clients), or any other wired or wireless computing device that is Internet enabled to allow for product search and purchase via the Internet. In exemplary embodiments, the computing device of the customer 204 has an e-commerce (buyer) module 402 downloaded (from the e-commerce server 202 of FIG. 2) and installed thereon.

As previously discussed, the e-commerce module 402 seamlessly integrates into the customer's computing device. The exemplary e-commerce module 402 may comprise a specialized browser technology optimized for e-commerce communication using the Internet without depending on existing HTML/XML browser technology. In a further embodiment, the e-commerce component 402 allows the customer 204 to set up favorite groups (of sellers) which can be searched, customize their search options, and perform other customization features.

Similarly, the vendor 206 comprises an e-commerce (seller) module 404. When the vendor 206 first registers with the e-commerce server 202 (FIG. 2), the e-commerce (seller) module 404 is downloaded and installed from the e-commerce server 202 onto their computing device. As with the commerce (buyer) module 402, the e-commerce (seller) module 404 may comprise a plug-in that seamless integrates with the vendor's computing device to allow direct access into an inventory database 406. Embodiments of the present invention remove the need for a central database (i.e., the prior art system of FIG. 1a), and instead, forward the query to available peers (i.e., vendors or retailers) to execute a real-time search at the retailer's own inventory database. That is, back end integration with legacy products utilizing plug-ins of the e-commerce module 404 allows direct access to the inventory database.

In exemplary embodiments, the e-commerce modules 402 and/or 404 comprise a non-repudiation protocol. This non-repudiation protocol insures integrity in the e-commerce environment. For example, the protocol may timestamp communication packets, thus providing a transaction date. In one embodiment, AS2 transport protocol is utilized to provide the non-repudiation protocol.

In the present embodiment, the customer 204 has direct access to, and communicates with, the vendor 206. Thus, the product search query is sent directly to the e-commerce (seller) module 404. The product search query may comprise a search using product codes, (whole, part, or sectional) product descriptions, part numbers, or any other flexible search criteria. Alternatively, the customer 204 may select a product from a (real or virtual) catalog. In yet further embodiments, the product search query may be from a bill of materials or any XML list. For example, the customer 204 creates a list of products they want priced, encapsulates them with XML tags (which may include a list of vendors to query), and forwards this file to the vendor 206. In alternative embodiments, non-XML tags may be utilized. Advantageously, this embodiment allows individuals who may not have a website to sell to their products.

The e-commerce (seller) module 404 receives the query and, via an open database connection (ODBC) 408, the inventory database 406 is searched for the requested information. The inventory database 406 is, in exemplary embodiments, the internal database utilized by the vendor 206 for maintaining their stock. Because the customer 204 can directly query the inventory database 406, the product data is the most current available and there is no need for a centralized database with “pushed” information. The requested information is then sent back via the e-commerce module 404 to the e-commerce (buyer) module 402. If the customer 204 decides to purchase an item from the vendor 206, a purchase communication is sent to the vendor 206.

In exemplary embodiments, copies of the communications between the customer 204 and the vendor 206 are made by the e-commerce module 404 at the vendor 206. The copies are then sent to the e-commerce server 202 in real time. Alternatively, the copies may be stored in a secure database. The secure database may be at the vendor 206 site or coupled to the vendor 206 on the Internet. Then at a predetermine time or when a predetermined number of copies are stored, the copies are forwarded to the e-commerce server 202. Alternatively at predetermined times, the e-commerce server 202 retrieves the information from the secure database. In yet further embodiments, not all communications are copied. For example, the e-commerce module 404 may only copy communications involving a purchase transaction.

In further embodiments, the e-commerce module 402 at the customer site may also make a copy of the communication packet. The copies are then either stored temporarily at a secure database or sent in real-time to the e-commerce server 202. In yet a further embodiment, copies of communication packets are not made, but instead, the communication packets are redirected through the e-commerce server 202.

Referring now to FIG. 5, an exemplary management scenario of an indirect product search is shown. In the indirect scenario, the queries and responses are directed through the information consolidator server 212. Thus in the present embodiment, a product search query is first forwarded to the information consolidator server 202 having an information consolidator engine 502. The product search query may comprise a search using product codes, (whole, part, or sectional) product descriptions, part numbers, or any other flexible search criteria. Alternatively, the customer 204 may select a product from a (real or virtual) catalog. In yet further embodiments, the product search query may be from a bill of materials or any XML list. In alternative embodiments, non-XML tags may be utilized.

Upon receiving the product search, the information consolidator engine 304 checks a coupled vendor database 504 to determine qualified vendors to whom to forward the query. The vendor database 504 may contain subdirectories of business-to-business, business-to-consumer, and business-to-government vendor information. Although only one vendor database 504 is shown, alternative embodiments may comprise any number of databases 504. In yet a further embodiment, the information consolidator server 212 may not include the vendor database 504, but instead, be coupled to one or more vendor databases 504.

Once the one or more proper vendors 206 are identified, the product search is forwarded to each vendor 206. In exemplary embodiments, the vendor 206 each have downloaded and installed the e-commerce module 404 to their Internet coupled computing device, and thus are enabled vendors. A business profile of the vendor 206 including name and address information may be stored in the vendor database 504 and used to determine search query access (i.e., where a product search query should be sent). Other information including descriptions for business attributes may be optionally provided to the vendor database 504. The business profile is then stored in the vendor database 504. The business profile may also be stored at the e-commerce server 202 during the downloading and/or installation of the e-commerce module 404.

The product search query is forwarded to the e-commerce module 404 at the vendor 206 site. The e-commerce module 404 checks a coupled inventory database 408 to determine inventory and pricing information based on the product search. In exemplary embodiments, the inventory database 408 is the same internal, inventory database maintained by the vendor 206, thus eliminating the need to copy inventory information to a searchable database. In exemplary embodiments, a keyword search may be performed on metadata, actual inventory, or both.

The search result is then sent to the customer 204 via the information consolidator server 212. For example, if the product search query comprises a XML list, then the result may be returned to the customer 204 and displayed in a XML format. Advantageously, the present invention allows the customer 204 to execute complex search queries with minimal effort and maximum results. In an alternative embodiment, the search result may be sent directly to the customer 204 without having to traverse through the information consolidator server 212. The result may be displayed based on any preferences set by the customer 204.

Should the customer 204 decide to purchase the product, the customer 204, in one embodiment, establishes a link with the vendor 206 and proceeds with purchase of the product(s) directly from the vendor 206. This eliminates the need for middle-men and allows small vendors without websites to reach a large number of prospective customers.

Copies of the communications between the customer 204, vendor 206, and information consolidator server 212 may be made by the e-commerce module 404. The copies are then sent to the e-commerce server 202 in a real time embodiment. Alternatively, the copies may be stored onto a secure database 410. The secure database 410 may be at the vendor site or coupled to the vendor site on the Internet. Subsequently at a predetermine time or when a predetermined number of copies are stored, the copies are forwarded to the e-commerce server 202. Alternatively, the e-commerce server 202 retrieves the copies. In yet further embodiments, not all communications are copied. For example, the e-commerce module 404 may only copy and forward communications involving a direct purchase transaction with the customer 204.

In further embodiments, the e-commerce module 402 at the customer 204 site may also make a copy of the communication packet. The copies are then either stored temporarily at a secure database or sent in real-time to the e-commerce server 202. In yet a further embodiment, copies of communication packets are not made, but instead, the communication packets are redirected through the e-commerce server 202.

Although the embodiments of FIG. 4 and 5 show only one customer 204 coupled in communication with one vendor 206. Embodiments of the present invention allows for one or more customers 204 to couple with one or more vendors 206 at the same time. Thus, for example, the customer 204 may be querying a plurality of vendors 206 simultaneously and obtaining real-time inventory and pricing information back from each vendor 206. This process eliminates the need for the customer 204 to visit multiple vendor websites in order to determine the best price, location, and so forth. Instead, multiple vendor prices and product comparisons may be provided to the customer 204 on a single display screen. Similarly, a vendor 206 may be providing inventory information to a plurality of customers 204 at the same time. Some or all of the communications between these customers 204 and vendors 206 may be copied and provided to the e-commerce server 202 for authentication or statistical purposes.

In a further embodiment, the communication packets may be intercepted by the e-commerce server 202 during transmission. For example, the routing management module 306 (FIG. 3) may direct that the communications be sent via the e-commerce server 202. That way, a copy of the communication may be made at the e-commerce server 202. Alternatively, two identical communication packets may be sent by the customer 204 and/or the vendor 206—one packet to the other party (i.e., the vendor 206 or the customer 204) and one packet to the e-commerce server 202.

In yet a further embodiment, the copies of the communications may be sent to a system administrator for a particular group of users. For example, a regional system administrator may collect the copies, and at predetermined intervals, forward the copies to the e-commerce server 202. In some embodiments, the secure database 410 is located at the system administrator.

It should be noted that the e-commerce (buyer) module 402 and the e-commerce (seller) module 404 may comprise similar functionalities. This is desirable when a customer 204 may also be a vendor 206. For example, a user may be a wholesale buyer (i.e., customer 204) from a whole seller, and, at the same time, we a retail vendor 206 to individual customers 204.

Referring now to FIG. 6, management in an exemplary e-community environment 600 is shown. An e-community is a collection of members, including both e-community customers 602 and e-community vendors 604 coupled via the Internet 606, which share a common interest. The e-community may be a public community where any user may join. Alternatively the e-community may be a private community in which only selected users are allowed to join. For example, a public community may be a stamp collecting community comprising stamp collectors, stamp sellers, stamp collecting societies, and so forth.

The e-community environment 600 may further comprise an e-community administrator 608. The e-community administrator 608 is responsible for the management of the particular e-community. In one embodiment, all members of the e-community register with the e-community administrator 608 in order to access other members of the e-community and/or to receive e-community communications. For example, a monthly newsletter may be sent to e-community members.

In embodiments of the present invention, the e-community administrator 608 receives some or all of the copies of communications (i.e., packets) sent between the various members of the e-community. This may occur after, or instead of, the temporary storage of the copies at the secure database. In some embodiments, the copies are routed to the administrator 608 for storage. The administrator 608 may then monitor the communications. For example, the administrator 608 can check for spam. Thus in a stamp e-community example, if a communication offering diet pills is detected by the administrator 608, the administrator 608 can remove the communication before the communication is sent to some or all of the members of the e-community.

In a further embodiment, the administrator 608 may selectively monitor communications in the e-community. For example, a long time member may not have his communications monitored, but a new member's communications may be monitored to ensure proper usage of the e-community. In yet a further embodiment, the administrator 608 may generate the statistical reports based on the stored copies of the transactions and provide the reports to the proper users.

In exemplary embodiments where the e-community administrator 608 temporarily stores the copies of the communications, the e-community administrator 608 may also send the copies to the e-commerce server 202. This may occur at predetermined intervals (e.g., every 2 hours, once a day). Alternatively, the copies may be sent when a certain number of copies has accumulated at the e-community administrator 608. In yet a further embodiment, the copies may be forwarded to the e-commerce server 202 manually by the e-community administrator 608, or the e-commerce server 202 retrieves the copies from the administrator 608. In yet a further embodiment, the administrator 608 is the e-commerce server 202 and functions as previously discussed.

In further embodiments of the present invention, the e-commerce server 202 may intercept the communications between the customers 204 and 602 and the vendors 206 and 604. For example, the routing management module 308 (FIG. 3) may provide routing which forwards the communications through the e-commerce server (e.g., a third address). By redirecting the communication packet(s) through the third address (e.g., e-commerce server 202 or the administrator 608), the system can monitor the communication packet(s). In the example with the administrator 608, the administrator 608 can receive the communication packet(s), strip the packet(s) in order to access the content, and if the content is permissible, redirect the packet(s) to the receiver.

In yet another alternative embodiment, a copy of the communication is made at each e-commerce module 402 and/or 404 (FIG. 4) substantially simultaneously with the sending of the communication. Subsequently, the e-commerce module 402 and/or 404 sends the copy to the e-commerce server 202 immediately thereafter. This allows for real-time monitoring of communications.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. A system for managing communications in an e-commerce environment comprising:
an e-commerce module configured to create a communication packet; and
an e-commerce server configured to obtain and monitor a copy of the communication packet.

2. The system of claim 1 wherein the e-commerce module is further configured to create the copy of the communication packet.

3. The system of claim 1 further comprising a secure database configured to temporarily store the copy of the communication packet.

4. The system of claim 1 wherein the e-commerce server comprises an authentication module configured to authenticate a user.

5. The system of claim 1 wherein the e-commerce server comprises a routing management module configured to direct the communication packet to the e-commerce server.

6. The system of claim 1 wherein the e-commerce server comprises a monitor module configured to perform statistical analysis on the copies of the communication packet.

7. The system of claim 1 wherein the e-commerce server comprises a monitor module configured to search for at least one transaction embodied in at least one copy of the communication packet.

8. The system of claim 1 wherein the e-commerce server comprises a communication interface configured to provide an e-commerce plug-in resulting in the e-commerce module.

9. The system of claim 1 further comprising an e-community administrator configured to monitor communications within an e-community.

10. The system of claim 9 wherein the e-commerce administrator is the e-community server.

11. The system of claim 1 wherein the e-commerce module comprises a non-repudiation protocol to insure integrity of the communication packet and the copy of the communication packet.

12. A method for managing communications in an e-commerce environment comprising:
storing at least one copy of a communication packet at a database associated with an e-commerce server, the communication packet associated with an e-commerce communication; and
reviewing the at least one copy of the communication packet.

13. The method of claim 12 further comprising creating the at least one copy of the communication packet at the e-commerce server.

14. The method of claim 12 further comprising redirecting the communication packet to the e-commerce server in order for the e-commerce server to review the communication packet.

15. The method of claim 12 further comprising creating the at least one copy at an e-commerce module while creating the communication packet.

16. The method of claim 12 further comprising temporarily storing the at least one copy of the communication packet at a secured database.

17. The method of claim 12 wherein the e-commerce server is an e-community administrator.

18. The method of claim 12 wherein the reviewing comprises authenticating a user associated with the copy of the communication.

19. The method of claim 12 wherein the reviewing comprises creating a statistical report based on the at least one copy of the communication.

20. The method of claim 12 wherein the reviewing comprises searching for at least one transaction embodied in at least one copy of the communication packet.

21. The method of claim 12 wherein the reviewing comprises accessing content of the communication packet or the copy of the communication packet.

22. A computer readable medium having embodied thereon program, the program being executable by a machine to perform a method for managing communications in an e-commerce environment, the method comprising:
storing at least one copy of a communication packet at a database associated with an e-commerce server, the communication packet associated with an e-commerce communication; and
reviewing the at least one copy of the communication packet.
